(19) United States
(12) Patent Application Publication
(10) Pub. No.: US 2009/0277252 A1
(43) Pub. Date: Nov. 12, 2009

(54) LEAKAGE DETECTING APPARATUS

(75) Inventors: Sang Hee SHIN, Seoul (KR); Ki Bong AHN, Seoul (KR)

Correspondence Address: Jason Y. Pahng and Associates, LLC, 12178 Bridgend Run, Fairfax, VA, 22030, US

(73) Assignee: JOONGANG CONTROL CO., LTD.

(21) Appl. No.: 12/431,773

(22) Filed: Apr. 29, 2009

(30) Foreign Application Priority Data
May 6, 2008 (KR) 10-2008-004170

(51) Int. Cl. G01M 3/18

(52) U.S. Cl. 73/49.1

(57) ABSTRACT

Provided is a leakage detecting apparatus that installs a detection pipeline for detecting a leakage on a pipe through which a liquid flows and determines whether liquid leaks from the pipe based on a voltage change of the detection pipeline there is provided a leakage detection apparatus for detecting whether a leakage has occurred by using a detection pipeline including a plurality of wires, the leakage detection apparatus including: the detection pipeline including first through third electric wires in which end portions of the first and second electric wires are electrically connected through a diode; a pipeline measuring unit, after a constant current is applied to the first electric wire, measuring a pipeline voltage at specific point of place of each of the second and third electric wires; and a microprocessor determining whether the leakage has occurred based on the pipeline voltage of each of the second and third electric wires.

### CROSS-REFERENCE TO RELATED PATENT APPLICATION

This application claims the benefit of Korean Patent Application No. 10-2008-0041870, filed on May 6, 2008, in the Korean Intellectual Property Office, the disclosure of which is incorporated herein in its entirety by reference.

### BACKGROUND OF THE INVENTION

1. Field of the Invention

The present invention relates to a leakage detecting apparatus, and more particularly to, a leakage detecting apparatus that installs a detection pipeline for detecting a leakage on a pipe through which a liquid flows and determines whether liquid leaks from the pipe based on a voltage change of the detection pipeline.

2. Description of the Related Art

Since pipes, such as water pipelines or oil pipelines, are generally buried underground, when a fluid leaks from a pipe due to a damage of the pipe or aging thereof, a leakage of the pipe is not detected in an early stage and instead is detected after the leakage of the fluid has occurred, which requires much time and expenses. To address these problems, a conventional method installs a detection pipeline for detecting a leakage in a pipeline and estimates a point of place where a leakage has occurred based on a measured voltage of the detection pipeline.

FIG. 1 illustrates a conventional leakage detecting apparatus. Referring to FIG. 1, the conventional leakage detecting apparatus installs a detection pipeline including four lines (2 detection lines and 2 normal lines) along a pipeline, applies a constant current to the detection pipeline, measures a voltage at a specific point of place, and determines whether the detection pipeline is disconnected or short-circuited. Also, the conventional leakage detecting apparatus changes a connection type of the detection pipeline by using a switch controlled by a control signal that is output by a microprocessor, applies the constant current to the detection pipeline, measures the voltage at the specific point of place, and determines whether and where a leakage has occurred.

If a voltage of a node N1 is measured with a first switch SW1 closed and a second switch SW2 opened, since a pipeline resistance of the detection pipeline per meter and a pipeline current that flows through the detection pipeline are known, the conventional leakage detecting apparatus can calculate the length of the detection pipeline. Also, if the voltage of the node N1 is measured with the first switch SW1 opened and the second switch SW2 closed, since the voltage of the node N1 can be predicted based on the calculated length of the detection pipeline, the conventional leakage detecting apparatus can determine if the detection pipeline is disconnected or is short-circuited.

If the voltage of the node N1 is measured with the first switch SW1 opened and the second switch SW2 opened, since the pipeline resistance of the detection pipeline per meter and the pipeline current that flows through the detection pipeline are known, the conventional leakage detecting apparatus can determine whether and where the leakage has occurred. If the leakage has not occurred, the voltage of the node N1 is 0V; whereas, if the leakage has occurred, the voltage of the node N1 is the same as a voltage of a point of place A where the leakage has occurred. Thus, the conventional leakage detecting apparatus can determine the point of place A where the leakage has occurred based on the voltage of the node N1.

FIG. 2 illustrates a conventional leakage detection pipeline. Referring to FIG. 2, the conventional leakage detection pipeline includes four lines (2 detection lines and 2 normal lines) in which detection lines and normal lines are twisted in order to prevent them from being separated from each other. The detection lines use relatively large resistance lines as core wires, and the normal lines use copper wire or iron wire as core wires. The detection lines and the normal lines are coated with vinyl so as to insulate them and prevent them from being damaged. Meanwhile, the normal lines are for determining whether the detection lines are disconnected, and the detection lines are for detecting whether liquid has leaked.

Meanwhile, the conventional leakage detecting apparatus uses a line in combination of the two detection lines and the two normal lines of which the connection status is controlled by a switch as the detection pipeline, which greatly increases expenses. Since the detection pipeline is installed in a pipe buried underground, like a water pipeline or an oil pipeline, the number of electric wires greatly affects the expenses. Therefore, a leakage detecting apparatus and a leakage detection pipeline capable of increasing detection efficiency while reducing the number of electric wires included in a detection pipeline are needed.

### SUMMARY OF THE INVENTION

The present invention provides a leakage detecting apparatus that connects an end portion of a leakage detection pipeline through a diode and controls a flow of a constant current being applied to the leakage detection pipeline by using a microprocessor, thereby efficiently detecting whether the leakage detection pipeline is disconnected and is short-circuited and whether a leakage has occurred while using the leakage detection pipeline including a small number of lines, and the leakage detection pipeline.

According to an aspect of the present invention, there is provided a leakage detection apparatus for detecting whether a leakage has occurred by using a detection pipeline including a plurality of wires, the leakage detection apparatus including: the detection pipeline including first through third electric wires in which end portions of the first and second electric wires are electrically connected through a diode; a pipeline measuring unit, after a constant current is applied to the first electric wire, measuring a pipeline voltage at specific point of place of each of the second and third electric wires; and a microprocessor determining whether the leakage has occurred based on the pipeline voltage of each of the second and third electric wires.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional leakage detecting apparatus;

FIG. 2 illustrates a conventional leakage detection pipeline;

FIG. 3 illustrates a leakage detecting apparatus according to an embodiment of the present invention;

FIG. 4 illustrates a leakage detection pipeline according to an embodiment of the present invention;

FIG. 5 illustrates a leakage detection pipeline according to another embodiment of the present invention;

FIG. 6 illustrates a leakage detection pipeline according to another embodiment of the present invention;

FIG. 7 is a block diagram of a leakage detection apparatus according to another embodiment of the present invention;

FIG. 8 is a circuit diagram of a pipeline measuring unit of FIG. 7, according to an embodiment of the present invention;

FIG. 9 is a circuit diagram of a constant current generating unit of FIG. 7, according to an embodiment of the present invention;

FIG. 10 is a diagram of a screen display unit of FIG. 7, according to an embodiment of the present invention;

FIG. 11 is a circuit diagram of an alarm unit of FIG. 7, according to an embodiment of the present invention;

FIG. 12 is a circuit diagram of a software input unit of FIG. 7, according to an embodiment of the present invention;

FIG. 13 is a circuit diagram of an external communication unit of FIG. 7, according to an embodiment of the present invention; and

FIG. 14 is a circuit diagram of a power supply unit of FIG. 7, according to an embodiment of the present invention.

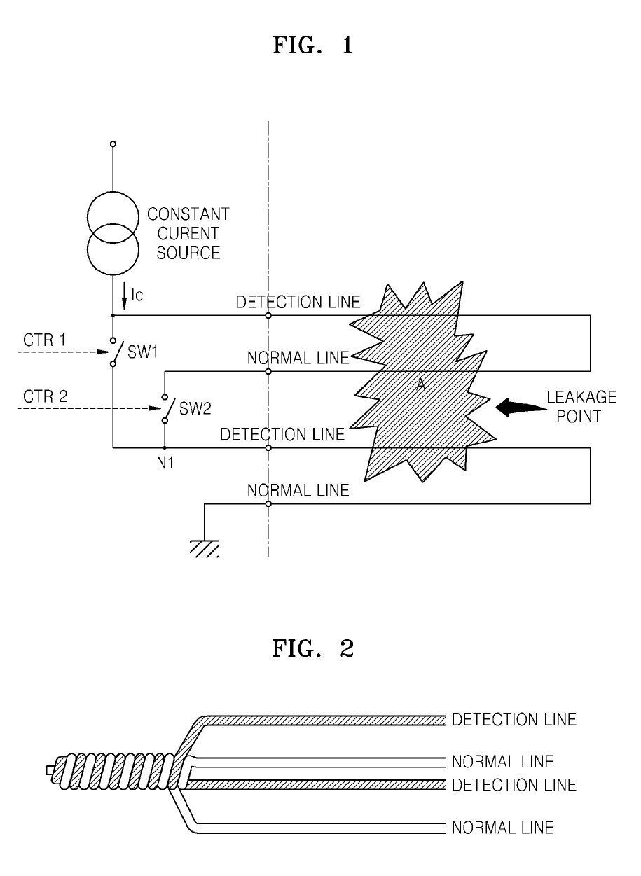

### DETAILED DESCRIPTION OF THE INVENTION

The attached drawings for illustrating exemplary embodiments of the present invention are referred to in order to gain a sufficient understanding of the present invention, the merits thereof, and the objectives accomplished by the implementation of the present invention.

Hereinafter, the present invention will be described more fully with reference to the accompanying drawings, in which exemplary embodiments of the invention are shown. While describing the present invention, detailed descriptions about related well-known functions or configurations that may blur the points of the present invention are omitted.

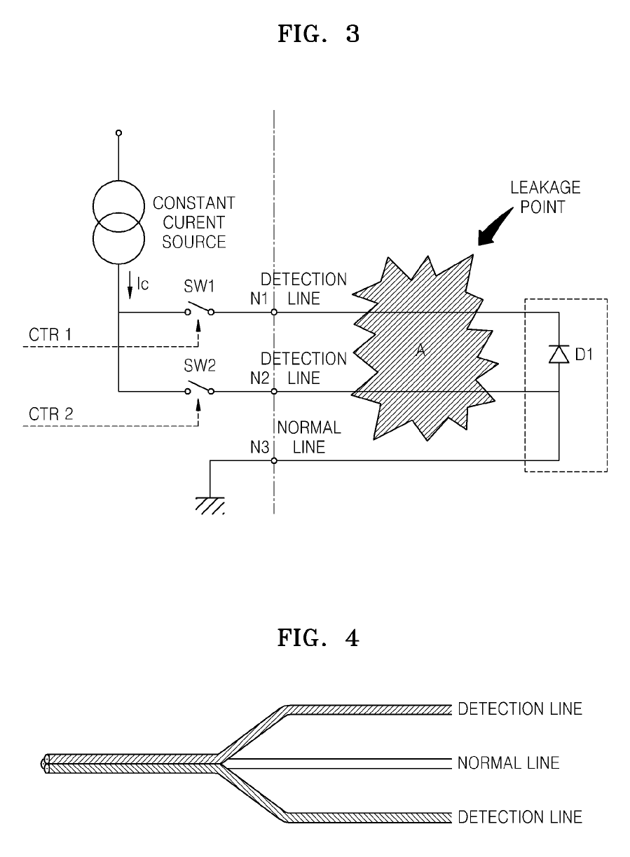

FIG. 3 illustrates a leakage detecting apparatus according to an embodiment of the present invention. Referring to FIG. 3, the leakage detecting apparatus of the present embodiment installs a detection pipeline including 3 lines (2 detection lines and 1 normal line) along a pipeline, applies a constant current to the detection pipeline, measures a voltage at a specific point of place, and determines whether the detection pipeline is disconnected and is short-circuited. Also, the leakage detecting apparatus changes a connection type of the detection pipeline by using a switch controlled by a control signal that is output by a microprocessor, applies the constant current to the detection pipeline, measures the voltage at the specific point of place, and determines whether and where a leakage has occurred.

If each voltage of two nodes N2 and N3 is measured with a first switch SW1 opened and a second switch SW2 closed, since a pipeline resistance of the detection pipeline per meter and a pipeline current that flows through the detection pipeline are known, the leakage detecting apparatus can calculate the length of the detection pipeline. Also, if the pipeline resistance of the two detection lines is X1 (Ω/M), the pipeline resistance of the one normal line is X2 (Ω/M), the voltage of the node N2 is V2 (V), the voltage of the node N3 is V3 (V), and a pipeline current of the detection pipeline is Ic (A), the length L of the detection pipeline can be calculated according to Equation 1 below.

$$L = \frac{ V 2 - V 3}{{I}_{C} ( X 1 + X 2 )} \qquad ( 1 )$$

If each voltage of the nodes N1 through N3 is measured with the first switch SW1 opened and the second switch SW2 closed, the leakage detecting apparatus can determine if the detection pipeline is disconnected and is short-circuited. If the detection pipeline is disconnected, since a current does not flow to the node N3, the voltage of the node N3 is 0V. If the detection pipeline is short-circuited, the voltages of the nodes N1 and N2 are the same as each other or the voltages of the nodes N2 and N3 are the same as each other.

If each voltage of the nodes N2 and N3 is measured with the first switch SW1 closed and the second switch SW2 opened, since the pipeline resistance of the detection pipeline per meter and the pipeline current that flows through the detection pipeline are known, the leakage detecting apparatus can determine whether and where the leakage has occurred. If the leakage has not occurred, since diode connecting the 2 detection lines prevents the flow of the current, the current does not flow between the nodes N2 and N3. Thus, the voltages of the nodes N2 and N3 are 0V.

Meanwhile, if the leakage has occurred, although a diode D1 connecting the 2 detection lines prevents the flow of the current, the current that flows through the node N1 due to liquid that leaked from a specific point of place flows between the nodes N2 and N3. Thus, the voltages of the nodes N2 and N3 are not 0V but a specific voltage, respectively. In particular, since the voltage of the node N2 is the same as a voltage of a point of place A where the leakage has occurred, if a difference between the voltages of the nodes N2 and N3 is calculated, the leakage detecting apparatus can determine the point of place A where the leakage has occurred.

FIG. 4 illustrates a leakage detection pipeline according to an embodiment of the present invention. Referring to FIG. 4, the leakage detection pipeline of the present embodiment includes 3 lines (2 detection lines and 1 normal line) in which the detection lines and the normal line are connected in a triangular shape in order to prevent them from being separated from each other and form a cord line. The detection lines use relatively large resistance lines (for example, nickel-chrome lines) as core wires to increase the measurement accuracy. The core wires of the detection lines may each have a diameter greater than 0.5 mm. The core wire of the normal line may have a diameter greater than 1.0 mm.

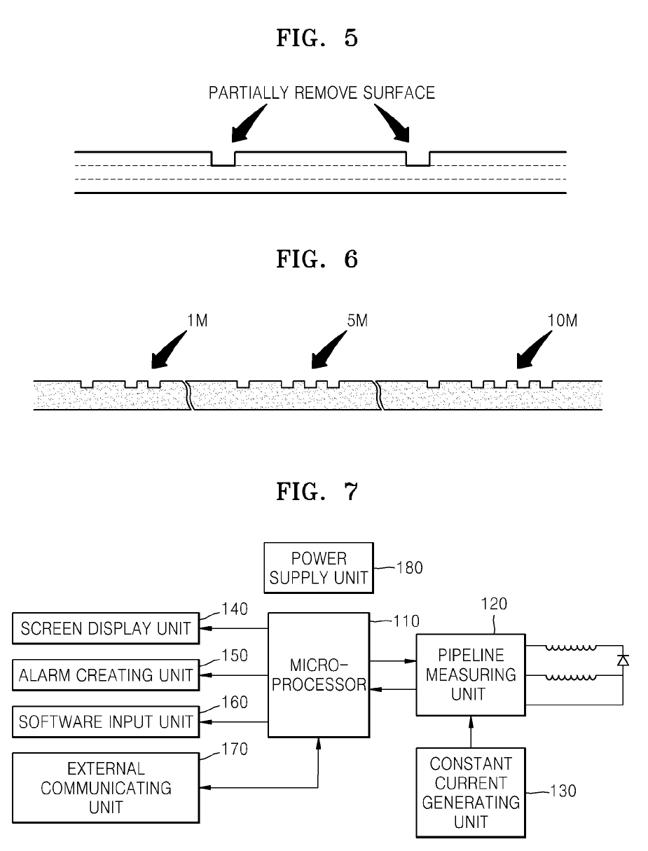

FIG. 5 illustrates a leakage detection pipeline according to another embodiment of the present invention. Referring to FIG. 5, the leakage detection pipeline of the present embodiment has its coating that surrounds the surface of a detection pipeline partially removed by a predetermined gap so as to detect a point of place where a liquid leakage has occurred. A coating removal width may be about 1 mm. A coating removal depth may be the same as the thickness of the coating so as to prevent a core wire from being damaged. A coating removal gap may be between about 1 cm and about 5 cm. However, the coating removal gap may be properly adjusted as necessary. Meanwhile, coating that surrounds a normal line is not removed.

FIG. 6 illustrates a leakage detection pipeline according to another embodiment of the present invention. Referring to FIG. 6, the leakage detection pipeline of the present embodiment indicates distances by partially removing coating that surrounds the surface of a detection pipeline by predetermined gaps for convenience of construction. The distances are indicated by continuously removing the coating twice in 1 M to indicate a distance of 1 M, continuously removing the coating three times in 5 M to indicate a distance of 5 M, and continuously removing the coating four times in 10 M to indicate a distance of 10 M. Meanwhile, coating that surrounds a normal line is not removed.

FIG. 7 is a block diagram of a leakage detection apparatus according to another embodiment of the present invention. Referring to FIG. 7, the leakage detection apparatus includes a microprocessor 110, a pipeline measuring unit 120, a constant current generating unit 130, a screen display unit 140, an alarm unit 150, a software input unit 160, an external communication unit 170, and a power supply unit 180. Hereinafter, the above elements will now be described in detail.

The microprocessor 110 sends a control signal to the pipeline measuring unit 120 and changes a flow of a constant current being applied to a detection pipeline by a predetermined period of time. The pipeline measuring unit 120 measures a node voltage and determines whether an accident has occurred in the detection pipeline. In particular, the microprocessor 110 determines whether the detection pipeline is disconnected and is short-circuited and whether a leakage has occurred based on the measured node voltage. The microprocessor 110 also controls the screen display unit 140, the alarm unit 150, the software input unit 160, and the external communication unit 170.

The pipeline measuring unit 120 is directly connected to the detection pipeline including two detection lines and one normal line and applies the constant current received from the constant current generating unit 130 to one of the two detection lines. In particular, the pipeline measuring unit 120 changes the two detection lines used to apply the constant current by using a switch controlled by the control signal received from the microprocessor 110. Meanwhile, end portions of the two detection lines and the one normal line are connected to each other, and one directional diode is connected between the two detection lines.

The constant current generating unit 130 generates the constant current having a predetermined amplitude irrespective of the size of a load resistance by using a driving power voltage received from the power supply unit 180, and supplies the constant current to the pipeline measuring unit 120. Also, the constant current generating unit 130 further includes a temperature compensation circuit for preventing a load current from changing since a reference voltage varies according to temperature. Also, the screen display unit 140 displays data received from the microprocessor 110 on a screen, and may include a light-emitting diodes (LEDs), a liquid crystal display (LCD), and Flexible Numeric Display(FND).

The alarm unit 150 creates an alarm light or an alarm sound based on the data received from the microprocessor 110. The software input unit 160 sends an input signal to the microprocessor 110 based on an operation input by a user. The external communication unit 170 transmits the data to a higher computer and receives data from the higher computer. The power supply unit 180 converts an alternating voltage of 220 V into a direct voltage of 5 V and supplies the direct voltage to another module. Although not shown, the leakage detection apparatus further includes a memory for storing the data.

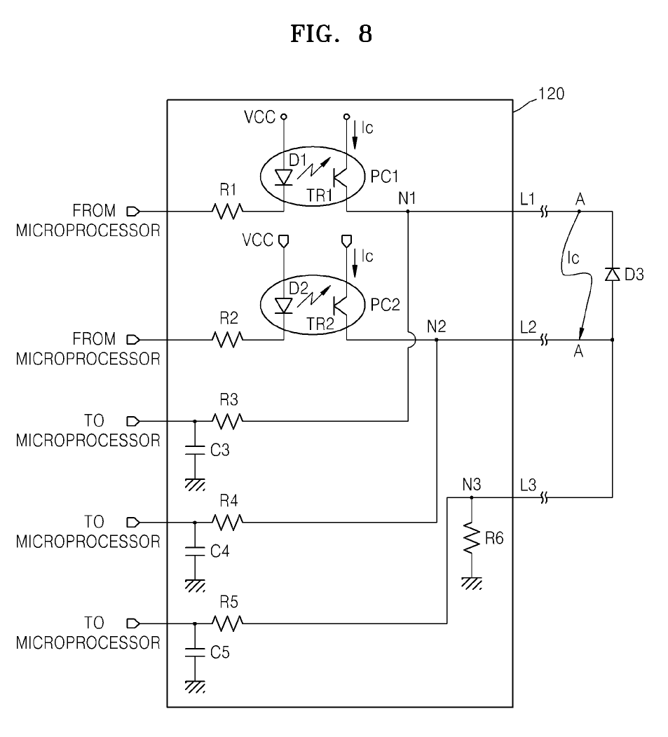

FIG. 8 is a circuit diagram of the pipeline measuring unit 120 of FIG. 7, according to an embodiment of the present invention. Referring to FIG. 8, the pipeline measuring unit 120 includes a plurality of resistors R1 through R6, a plurality of capacitors C3 through C5, and a plurality of photocouplers PC1 and PC2. Hereinafter, the above elements will now be described in detail. In particular, methods of calculating the length of a pipeline, detecting a disconnection, detecting a short-circuit, detecting a leakage, detecting a point of place where a leakage has occurred, and the like will now be sequentially described.

The photocouplers PC1 and PC2 respectively include two diodes D1 and D2 and two transistors TR1 and TR2. When a current flows through the diodes D1 and D2, the transistors TR1 and TR2 operate. The resistors R1 and R2 are elements for allowing a predetermined current to flow through the photocouplers PC1 and PC2. If a low-level control signal is applied to the resistors R1 and R2, the transistors TR1 and TR2 operate due to the current that flows trough the diodes D1 and D2, and a constant current Ic flows through detection lines L1 and L2. The resistors R3 through R5 are combined with the capacitors C3 through C5, respectively, and each combination serves as a low pass filter.

A method of calculating the length of the pipeline will now be described. The constant current Ic flows through the detection line L2 by applying the low-level control signal to the resistor R2, and the constant current Ic that flows through the detection line L2 flows through the resistor R6 through a normal line L3. Each voltage of nodes N2 and N3 is measured, and a difference between the voltages of the nodes N2 and N3 is calculated. The length of the pipeline is calculated based on the difference between the voltages of the nodes N2 and N3, the pipeline resistance of the detection line L2 and the normal line L3, and a pipeline current.

A method of detecting a disconnection will now be described. The constant current Ic flows through the detection line L2 by applying the low-level control signal to the resistor R2. A voltage of the node N3 is measured. It is determined whether the detection line L2 or the normal line L3 is disconnected based on the voltage of the node N3.

When the detection line L2 or the normal line L3 is disconnected, since the constant current Ic does not flow through the resistor R3, the voltage of the node N3 is 0V.

A method of detecting a short-circuit will now be described. The constant current Ic flows through the detection line L2 by applying the low-level control signal to the resistor R2. Each voltage of the nodes N1 through N3 is measured. It is determined whether the detection pipelines L1 and L2 and the normal line L3 are disconnected based on the voltages of the nodes N1 through N3. When the detection pipelines L1 and L2 and the normal line L3 are disconnected, the voltages of the nodes N1 and N2 are the same as each other or the voltages of the nodes N2 and N3 are the same as each other.

A method of detecting a leakage will now be described. The constant current Ic flows through the detection line L1 by applying the low-level control signal to the resistor R1. Each voltage of the nodes N2 and N3 is measured. It is determined whether a leakage has occurred based on the voltages of the nodes N2 and N3. When the leakage has not occurred, since the constant current Ic does not flow through the detection line L2 by an inverse direction diode D3, the voltage of the node N3 is 0V.

A method of detecting the point of place where the leakage has occurred will now be described. The constant current Ic flows through the detection line L2 by applying the low-level control signal to the resistor R1. Each voltage of the nodes N2 and N3 is measured. A difference between the voltages of the nodes N2 and N3 is calculated. The point of place where the leakage has occurred is calculated based on the difference between the voltages of the nodes N2 and N3, the pipeline resistance of the detection pipelines L1 and L2, and a pipeline current. When the leakage has occurred, the constant current Ic flows through the normal line L3 through the detection line L2.

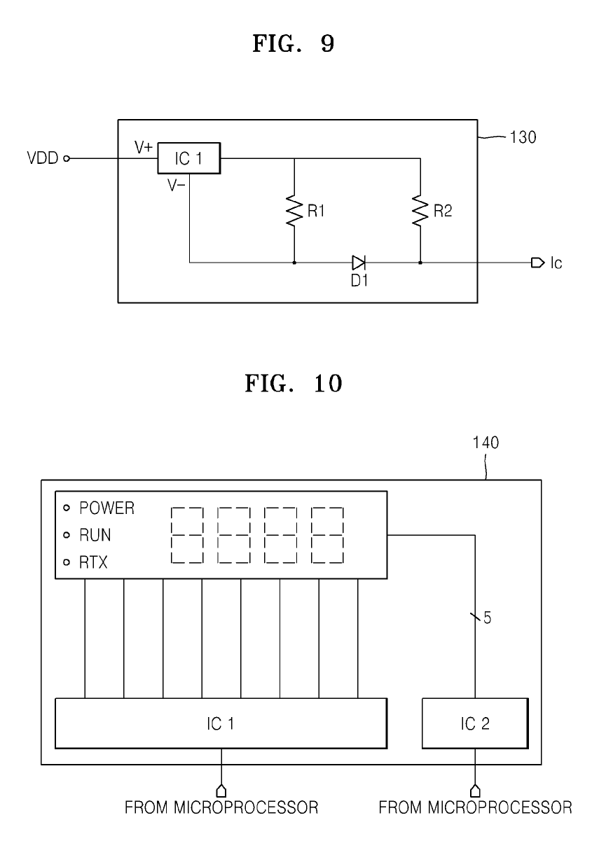

FIG. 9 is a circuit diagram of the constant current generating unit 130 of FIG. 7, according to an embodiment of the present invention. Referring to FIG. 9, the constant current generating unit 130 includes a reference voltage adjustment integrated circuit IC1, a plurality of resistors R1 and R2, and a diode D1. The elements will now be described in detail. In particular, temperature compensation circuit elements R2 and D1 will also be described.

The reference voltage adjustment integrated circuit IC1 maintains a reference voltage applied to both ends. For example, when a surrounding temperature is 25° C., the reference voltage applied to both ends of the reference voltage adjustment integrated circuit IC1 is maintained as 67.7 mV. In particular, when a load current Ic changes due to a change in the size of a load resistance, the reference voltage adjustment integrated circuit IC1 changes the reference voltage applied to both ends according to the change in the load current Ic. For example, if a reduction in the load resistance results in an increase in the load current Ic, a constant current is generated by reducing the reference voltage, and if an increase in the load resistance results in a reduction in the load current Ic, the constant current is generated by increasing the reference voltage.

Meanwhile, although the load resistance remains unchanged, the reference voltage of the reference voltage adjustment integrated circuit IC1 varies according to the surrounding temperature, which may result in a change in the load current Ic. For example, if the surrounding temperature increases by 1° C., the reference voltage of the reference voltage adjustment integrated circuit IC1 increases by 277 μV. Thus, a circuit is needed to compensate for the change in the reference voltage according to the surrounding temperature. To this end, the present embodiment uses the diode D1. If the surrounding temperature increases by 1° C., a both end voltage? is reduced to 2.6 mV. Thus, the characteristic of the diode D1 may be used to compensate for the change in the reference voltage according to the surrounding temperature.

In more detail, if the surrounding temperature increases, voltages at both terminals of the resistor R1 increase, and a current flowing through the resistor R1 increases. However, if the surrounding temperature increases, voltages of both terminals of the diode D1 are reduced and a current flowing through the resistor R2 is reduced. Thus, the resistors R1 and R2 are adjusted to offset an increase in the current flowing through the resistor R1 and a reduction in the current flowing through the resistor R2, thereby generating the constant current irrespective of the surrounding temperature. In particular, the resistance of the resistor R2 may be 10 times that of the resistor R1.

FIG. 10 is a diagram of the screen display unit 140 of FIG. 7, according to an embodiment of the present invention. Referring to FIG. 10, the screen display unit 140 includes a plurality of LEDs (POWER, RUN, and RTX), a plurality of Flexible Numeric Displays(FNDs), and a plurality of integrated circuits (IC1 and IC2). Hereinafter, the elements will now be described in detail.

The integrated circuits IC1 and IC2 are transistor array ICs and amplify data received from the microprocessor as a signal that can be displayed by the LEDs or the FNDs. POWER LED is turned on if power is normally supplied and is turned off if power is not normally supplied. RUN LED is turned on if a detection pipeline is normal and is turned off if the detection pipeline is abnormal. RTX LED is turned on if a communication status is normal and is turned off if the communication status is abnormal. The FNDs have a turned off status and if a leakage occurs, displays a distance of a point of place where the leakage has occurred with one digit after a decimal point.

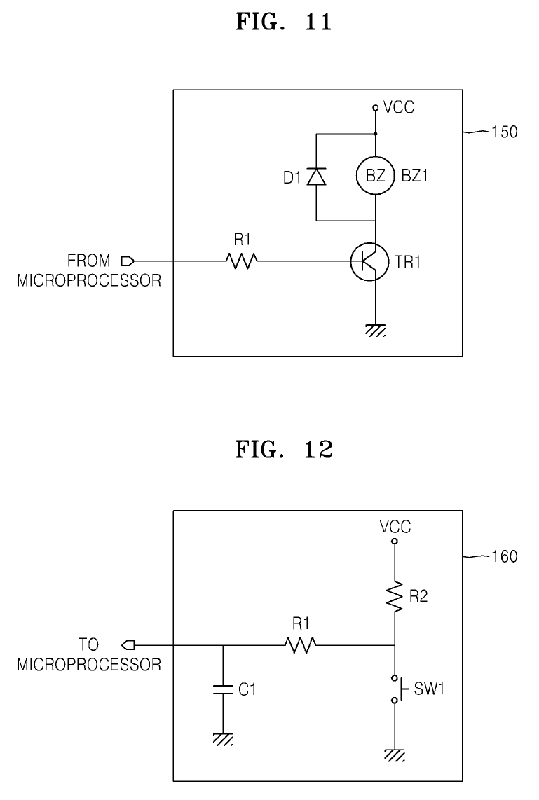

FIG. 11 is a circuit diagram of the alarm unit 150 of FIG. 7, according to an embodiment of the present invention. Referring to FIG. 11, the alarm unit 150 includes a resistor R1, a transistor TR1, a diode D1, and a buzzer BZ1. Hereinafter, the elements will now be described in detail.

A control signal received from the microprocessor is transmitted to the transistor TR1 through the resistor R1, and if a high-level control signal is input, the transistor TR1 operates and the boozer BZ1 operates. The diode D1 prevents reactance noise generated by the boozer BZ1. The microprocessor outputs the control signal for operating the boozer BZ1 if a leakage occurs in a detection pipeline.

FIG. 12 is a circuit diagram of the software input unit 160 of FIG. 7, according to an embodiment of the present invention. Referring to FIG. 12, the software input unit 160 includes a capacitor C1, a plurality of resistors R1 and R2, and a press switch SW1. Hereinafter, the elements will now be described in detail.

The resistor R1 and the capacitor C1 perform a high pass filter function and a chattering prevention function. The resistor R2 performs a function of pulling-up a node voltage. The press switch SW1 is used by a user to control a leakage detection apparatus. If the user presses the press switch SW1 once while an alarm rings, the alarm stops and a distance between a reference point and a point of place where the leakage has occurred is displayed on the screen display unit 140 with one digit after a decimal point. After the leakage is repaired, if the press switch SW1 is pressed for a long period of time, the point of place where the leakage has occurred is not displayed.

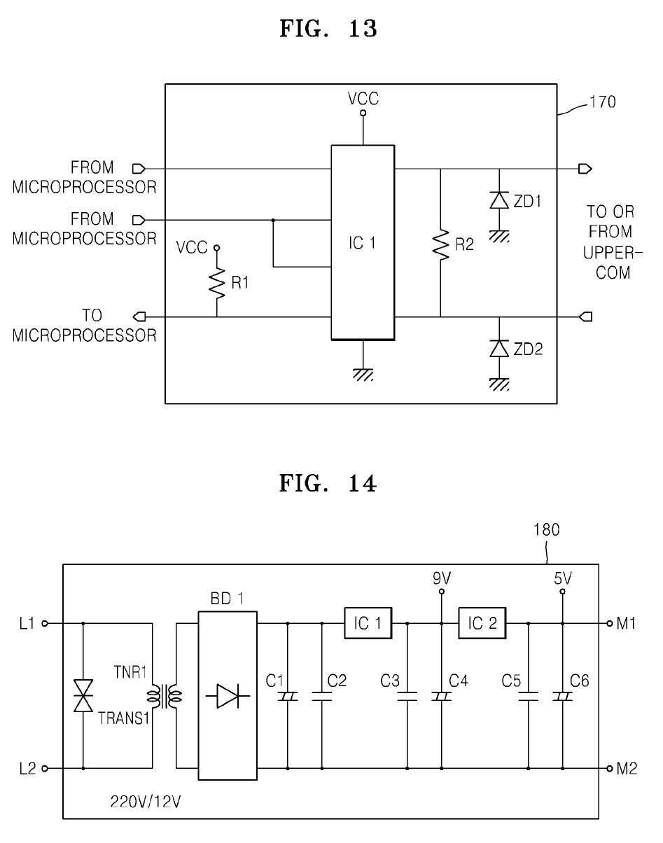

FIG. 13 is a circuit diagram of the external communication unit 170 of FIG. 7, according to an embodiment of the present invention. Referring to FIG. 13, the external communication unit 170 includes a data conversion integrated circuit IC1, a plurality of resistors R1 and R2, and a plurality of Zener diodes ZD1 and ZD2. Hereinafter, the elements will now be described in detail.

The data conversion integrated circuit IC1 converts data that is to be transmitted into a signal RS-485, transmits the data to a higher computer, converts data transmitted from the higher computer into a signal that can be recognized by the microprocessor, and transmits the signal to the microprocessor. The Zener diodes ZD1 and ZD2 remove noise or an erroneous signal included in a communication pipeline. The resistor R1 is a communication pipeline end resistor. The resistor R2 is a receiving end pull-up resistor. The higher computer is used to manage a leakage detection apparatus. The microprocessor transmits notice data to the higher computer if a disconnection/short-circuit/leakage occurs.

FIG. 14 is a circuit diagram of the power supply unit 180 of FIG. 7, according to an embodiment of the present invention. Referring to FIG. 14, the power supply unit 180 includes a TNR element(varistor) TNR1, a transformer TRANS1, a bridge diode BD1, a plurality of capacitors C2, C3, and C5, a plurality of electrolytic capacitors C1, C4, and C6, and a plurality of constant voltage regulators IC1 and IC2. Hereinafter, the elements will now be described in detail.

The TNR element TNR1 receives AC 220V and removes an overvoltage and noise. The transformer TRANS1 converts AC 220V into AC 12V. The bridge diode BD1 rectifies a wave of AC 12V and generates DC 12V. The electrolysis capacitors C1 and C4, the capacitors C2 and C3, and the constant voltage regulator IC1 generate DC 5V from DC 9V, where DC 5V is used in a circuit relating to a microprocessor.

As described above, a leakage detection apparatus of the present invention can effectively detect a leakage that might occur in a pipeline while using a detection pipeline including a small number of electric wires as compared to a conventional detection pipeline, thereby reducing expenses.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A leakage detection apparatus for detecting whether a leakage has occurred by using a detection pipeline including a plurality of wires, the leakage detection apparatus comprising:
the detection pipeline including first through third electric wires in which end portions of the first and second electric wires are electrically connected through a diode;
a pipeline measuring unit, after a constant current is applied to the first electric wire, measuring a pipeline voltage at specific point of place of each of the second and third electric wires; and
a microprocessor determining whether the leakage has occurred based on the pipeline voltage of each of the second and third electric wires.

2. The leakage detection apparatus of claim 1, wherein the microprocessor calculates a point of place where the leakage has occurred based on a difference between the pipeline voltages of the second and third electric wires.

3. The leakage detection apparatus of claim 2, wherein the microprocessor calculates the point of place where the leakage has occurred by using a pipeline resistance of the second and third electric wires per meter.

4. The leakage detection apparatus of claim 3, wherein the microprocessor calculates the point of place where the leakage has occurred by using the constant current that flows through the second and third electric wires.

5. The leakage detection apparatus of claim 1, wherein the first and second electric wires have a greater resistance value than the third electric wire.

6. The leakage detection apparatus of claim 5, wherein the first and second electric wires include core wires formed of nickel and chrome.

7. The leakage detection apparatus of claim 5, wherein the first and second electric wires are surrounded with a coating that is partially removed by a predetermined gap.

8. The leakage detection apparatus of claim 7, wherein the first and second electric wires are surrounded with a coating in which a distance is indicated by a predetermined gap.

9. The leakage detection apparatus of claim 1, wherein the first through third electric wires are connected in a triangular shape.

10. The leakage detection apparatus of claim 1, wherein the pipeline measuring unit comprises a switch relays the constant current to the detection pipeline.

11. The leakage detection apparatus of claim 10, wherein the switch operates according to a control signal output from the microprocessor.

12. The leakage detection apparatus of claim 11, wherein the switch is a photocoupler.

13. The leakage detection apparatus of claim 1, further comprising: a constant current generating unit generating the constant current.

14. The leakage detection apparatus of claim 13, wherein the constant current generating unit comprises a compensation circuit compensating for a voltage change according to temperature.

15. The leakage detection apparatus of claim 14, wherein the constant current generating unit comprises the compensation circuit including a diode and resistors.

16. The leakage detection apparatus of claim 1, wherein the pipeline measuring unit measures a pipeline voltage at a specific point of place of each of the second and third electric wires after the constant current is applied to the second electric wire, and
wherein the microprocessor calculates the length of the detection pipeline based on a difference between pipeline voltages of the first and second electric wires.

17. The leakage detection apparatus of claim 16, wherein the pipeline measuring unit measures a pipeline voltage at a specific point of place of the third electric wire after the constant current is applied to the second electric wire, and
wherein the microprocessor determines whether the detection pipeline has been disconnected based on the voltage of the third electric wire.

18. The leakage detection apparatus of claim 17, wherein the pipeline measuring unit measures a pipeline voltage at a specific point of place of each of the first through third electric wires after the constant current is applied to the second electric wire, and
wherein the microprocessor determines whether the detection pipeline has been short-circuited based on a difference between the voltages of the first through third electric wires.
